(19) United States
(12) Patent Application Publication
(10) Pub. No.: US 2018/0319137 A1
(43) Pub. Date: Nov. 8, 2018

(54) ANTIFOG FILM WITH PEELABLE FUNCTIONALITY

(71) Applicant: COVERIS FLEXIBLES US LLC, Chicago, IL (US)

(72) Inventors: Thomas Lee, Appleton, WI (US); Cody Mischel, Appleton, WI (US); David McKnight, Battle Creek, MI (US)

(21) Appl. No.: 16/039,218

(22) Filed: Jul. 18, 2018

Related U.S. Application Data
(63) Continuation of application No. 15/026,833, filed on Apr. 1, 2016.
(60) Provisional application No. 61/887,249, filed on Oct. 4, 2013.

(51) Int. Cl. B32B 27/08; B32B 27/30; B32B 27/32; B32B 27/36; B32B 7/12; C08J 7/04; B32B 38/00

(52) U.S. Cl. CPC B32B 27/08; B32B 2439/70; B32B 27/32; B32B 27/36; B32B 7/12; C08J 7/04; B32B 2307/748; B32B 2307/732; B32B 2307/73; B32B 2307/518; B32B 2307/4023; B32B 2307/40; B32B 2307/31; B32B 2270/00; B32B 2255/26; B32B 2255/24; B32B 2255/10; B32B 2250/246; B32B 2250/24; B32B 2250/03; B32B 38/145; B32B 2307/75; B32B 2323/10; B32B 2367/00; B32B 2435/00; B32B 2439/46; B32B 27/306

(57) ABSTRACT

The present invention provides a multilayer polymeric film structure having an outer layer that is adhered to an inner layer. The inner layer comprises a blown film and may be coated with a peelable antifog coating. In some embodiments, the antifog coating comprises ethyl alcohol and nitrocellulose. The external and inner layers may be bonded together with an adhesive layer. The film structure may be configured to hold a food product such as produce, meat, and/or cheese.

### TECHNICAL FIELD

The present disclosure relates generally to the field of packaging material, including, but not limited to, food packaging material.

### BRIEF DESCRIPTION OF THE DRAWINGS

FIG. 1 shows an exemplary flexible pouch made of a peelable antifog film as described herein.

FIG. 2 shows an exemplary rigid tray with a lid made of a peelable antifog film as described herein.

FIG. 3 shows an embodiment that comprises three layers as described herein.

### DESCRIPTION

Many products, including food products, contain water or are preferably stored under conditions of high humidity. It is desirable to visually observe the product through the packaging material. Consequently, a packaging material that comprises antifog properties is desirable. In addition, it is also desirable for the package to be easy to open without the use of a device such as scissors. One design of such a package is to incorporate a peelable opening feature. Certain products are packaged in quantities that are utilized or consumed over time. Such products may be degradable when exposed to the atmosphere outside of the packaging material. Consequently, a package that may be opened then resealed is also desirable. While peelable packaging is known in the art, it remains difficult to develop polymeric film structures that are both heat sealable and peelable. Specific difficulty is faced when it is desirable to provide antifog polymeric structures for heat sealing and for peelable heat sealing. In some embodiments, the peelable film may be resealable. The present disclosure describes film structures which may be used as packaging material that is both heat sealable, antifog, and peelable. In certain embodiments, it is also resealable.

The present disclosure describes embodiments of a reverse printed film which is laminated with a blown sealant film. Materials that may comprise the reverse printed film include, but are not limited to, oriented polypropylene (OPP) or polyethylene terephthalate (PET) films. The blown sealant film is applied to the reverse printed film using techniques known in the art, without limitation, including intaglio printing processes. Examples of such processes include the use of a Rotogravure or Flexographic press.

In certain embodiments, the peelable seal includes a tamper evident feature. The peelable seal may provide a visual whitening in the seal area after it has been opened. It is therefore evident to the user that the package has been previously opened. This may be useful in instances when the disclosed polymeric film structures is used to package food products in which tampering represents a safety concern. In embodiments which will be used to package food products, the film will be configured to comply with the relevant food safety regulations.

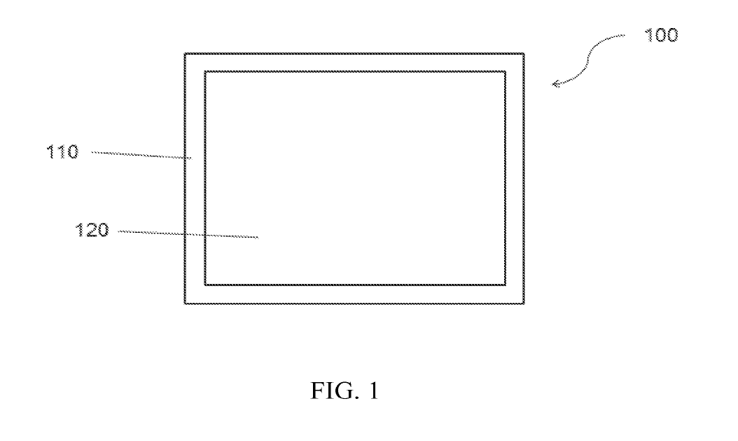

The films disclosed herein may be used to create a flexible pouch as shown in FIG. 1. The flexible pouch 100 of FIG. 1 includes a peelable seal 110 and an antifog window 120 in the package. In some embodiments, the peelable seal 110 may be reclosable. In some embodiments, the pouch holds a food product. In some embodiments, the food product comprises produce.

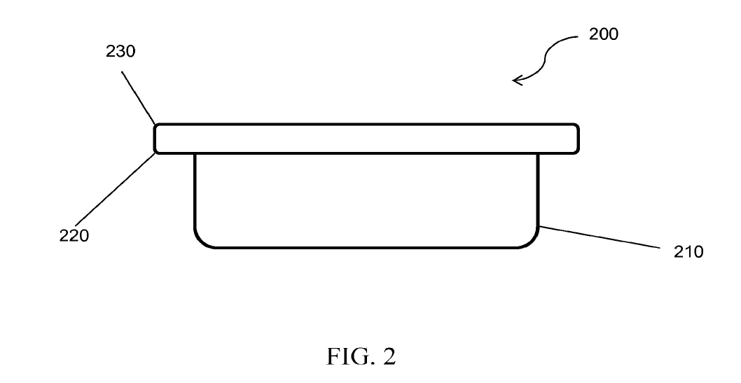

Alternatively, the films disclosed herein may be used to create a peelable lid on a tray 200 as shown in FIG. 2. The tray 200 comprises a rigid tray 210 with a lid 220. The lid 220 comprises a peelable seal 230. The tray 210 may be made of any appropriate polymer, such as polypropylene (PP), polyethylene terephthalate (PET), polyethylene terephthalate polyester (PETP), low density polyethylene (LDPE) including LLDPE, medium density polyethylene (MDPE), high density polyethylene (HDPE), high impact polystyrene (HIPS). In an embodiment, the tray 210 comprises PP. In some embodiments, the tray 200 holds a food product. In some embodiments the food product comprises contain meat and/or cheese. Examples of a peelable packaging structure include those described in U.S. Pat. No. 7,717,620 which is hereby incorporated by reference in its entirety.

The film structures disclosed herein may contain multiple layers. Such films may comprise an internal layer that comprises a blown film layer. This layer may contain PE, such as LLDPE, MDPE or HDPE. The blown film layer may be a blend, including a blend with EVA (ethylene vinyl acetate). The blown film layer may be the inner layer (in contact with or closest to the product enclosed in the pouch or tray). As described herein, the internal layer is the layer of the film structure that is adjacent with the contents of the packaging, such as a food product.

In certain embodiments, the blown film is coated with an antifog coating. An example of an antifog coating comprises ethyl alcohol and nitrocellulose, such as ACC-Clear™ 9094 Seal-Thru™ Anti-Fog Concentrate available from ACC Coatings.

The structures may also comprise an external layer of PET or oriented polypropylene (OPP). The OPP may be oriented, including biaxially oriented, or it may be unoriented. As described herein, the external layer is the layer of the film structure that is in contact with the environment, and is the layer that is touched by a consumer holding the pouch or tray.

The external and inner layer may have an adhesive layer between them. The adhesive may be a PE extrusion or laminated via adhesive lamination. One or more known adhesives can be used to join the external layer and the inner layer. In some embodiments, the adhesive can comprise a water-adhesive in a mixture, or can comprise a 100% solids glue. The adhesive may include a component selected from the group consisting of styrene-isoprene-styrene copolymers, styrene-butadiene-styrene copolymers, ethylene ethyl acrylate copolymers, polyurethane reactive adhesives, tackifiers, waxes, paraffin, antioxidants, plasticizers, plant sterols, terpene resins, polyterpene resins, turpentines, hydrocarbon resins, resin acids, fatty acids, polymerized rosins, and polyamide adhesives. Furthermore, the adhesive may comprise ethylene vinyl acetate (EVA) copolymers, which can be compatible with paraffin; styrene-isoprene-styrene (SIS) copolymers; styrene-butadiene-styrene (SBS) copolymers; ethylene ethyl acrylate copolymers (EEA); and polyurethane reactive (PUR).

For example, in some embodiments, the adhesive can comprise a radiation-cured adhesive, a solventless adhesive, a solvent-based adhesive, or a water-based adhesive. The multilayer structure may contain three layers, and in an embodiment comprises an outer layer of OPP or PET, a middle layer of adhesive, and an inner layer that comprises the blown film which is coated with the peelable antifog coating. The outer layer may be about 36 to about 300 gauge OPP or about 36 to about 300 gauge PET. The blown film may be from 1.0 mil to 5 mil thick. In one embodiment, the blown film comprises an LLDPE, EVA blend. The outer layer is the most external layer of the packaging and that which is exposed to the external environment. The inner layer is that layer that is adjacent to the contents of the packaging. The middle layer is positioned between the inner and outer layers.

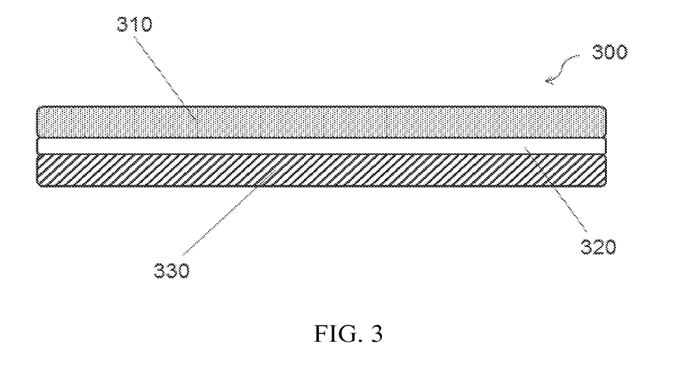

FIG. 3 shows an embodiment of a multilayer structure 300 as disclosed herein. The multilayer structure 300 comprises an external layer 310 comprised of OPP or PET, a middle layer 320 comprised of adhesive, and an inner layer 330 comprised of blown film. The blown film is coated with a peelable antifog coating as described herein.

### EXAMPLES

The following example is an embodiment of the present disclosure. In the present example, the coating is applied as a liquid on a flexorotor press. The multilayer film structure comprises PET film/Adhesive/Blown film/peelable antifog coating. The blown film layer in this example is produced by Exopack and marketed as Sclairfilm A353®, linear low density polyethylene+EVA. The coating on the inner layer is ACC-Clear™ M 9094 Seal-Thru™ Anti-Fog Concentrate.

Other embodiments include the following:
36-300 gauge PET film/Adhesive/Blown film 1.0-5 mil thick LLDPE, EVA blend/nitrocellulose+ethyl alcohol coating.
36-300 gauge OPP film/Adhesive/Blown film 1.0-5 mil thick LLDPE, EVA blend/ nitrocellulose+ethyl alcohol coating.
36-300 gauge PET film/ PE extrusion/Blown film 1.0-5 mil thick LLDPE, EVA blend/ nitrocellulose+ethyl alcohol coating.
36-300 gauge OPP film/ PE extrusion/Blown film 1.0-5 mil thick LLDPE, EVA blend/ nitrocellulose+ethyl alcohol coating.

We claim:

1. A multilayer polymeric film structure comprising an external layer bonded to an inner layer, the inner layer comprising a blown film, wherein the blown film comprises an antifog coating.

2. The multilayer polymeric film structure of claim 1, wherein the antifog coating is peelable.

3. The multilayer polymeric film structure of claim 1, wherein the antifog coating comprises ethyl alcohol and nitrocellulose.

4. The multilayer polymeric film structure of claim 1, wherein the external layer comprises a reverse printed film.

5. The multilayer polymeric film structure of claim 4, wherein the inner layer is applied to the reverse printed film using an intaglio printing process.

6. The multilayer polymeric film structure of claim 1, wherein the external layer comprises one or more of the group consisting of oriented polypropylene, unoriented polypropylene, and polyethylene terephthalate.

7. The multilayer polymeric film structure of claim 6, wherein the oriented polypropylene is biaxially oriented.

8. The multilayer polymeric film structure of claim 1, wherein the inner layer comprises polyethylene.

9. The multilayer polymeric film structure of claim 8, wherein the polyethylene comprises one or more of the group consisting of LLDPE, MDPE, and HDPE.

10. The multilayer polymeric film structure of claim 1, wherein the inner layer comprises a polymer blend.

11. The multilayer polymeric film structure of claim 10, wherein the polymer blend comprises ethylene vinyl acetate.

12. The multilayer polymeric film structure of claim 1, wherein the inner layer is between about 1.0 mil and about 5 mil thick.

13. The multilayer polymeric film structure of claim 1, wherein the external layer is between about 36 gauge and about 300 gauge.

14. The multilayer polymeric film structure of claim 1, wherein the external layer is bonded to the inner layer with an adhesive layer.

15. The multilayer polymeric film structure of claim 14, wherein the adhesive layer comprises one or more of the group consisting of styrene-isoprene-styrene copolymer, a styrene-butadiene-styrene copolymer, an ethylene ethyl acrylate copolymer, a polyurethane reactive adhesive, a tackifier, a wax, a paraffin, an antioxidant, a plasticizer, a plant sterol, a terpene resin, a polyterpene resin, a turpentine, a hydrocarbon resin, a resin acid, a fatty acid, a polymerized rosin, a polyamide adhesive, and an ethylene vinyl acetate (EVA) copolymer.

16. The multilayer polymeric film structure of claim 14, wherein the adhesive material comprises one or more of the group consisting of a radiation-cured adhesive, a solventless adhesive, a solvent-based adhesive, and a water-based adhesive.

17. The multilayer polymeric film structure of claim 1, wherein the film is configured to hold a food product.

18. The multilayer polymeric film structure of claim 17, wherein the food product is selected from one or more of the group consisting of produce, meat, and cheese.
